(19) United States
(12) Patent Application Publication
(10) Pub. No.: US 2013/0020303 A1
(43) Pub. Date: Jan. 24, 2013

(54) HEATING ELEMENT AND METHOD FOR MANUFACTURING SAME

(71) Applicants: Sujin Kim, Daejeon (KR); Ki-Hwan Kim, Daejeon (KR); Young Jun Hong, Daejeon (KR); Hyeon Choi, Daejeon (KR)

(72) Inventors: Sujin Kim, Daejeon (KR); Ki-Hwan Kim, Daejeon (KR); Young Jun Hong, Daejeon (KR); Hyeon Choi, Daejeon (KR)

(21) Appl. No.: 13/638,485

(22) PCT Filed: Mar. 30, 2011
(86) PCT No.: PCT/KR2011/002190

§ 371 Date: Sep. 28, 2012

(30) Foreign Application Priority Data
Apr. 1, 2010 (KR) 10-2010-0030030

(51) Int. Cl. H05B 3/84; H01C 17/06; B60L 1/02

(52) U.S. Cl. 219/203; 219/522; 29/611; 29/620

(57) ABSTRACT

The present invention relates to a heating element and to a method for manufacturing same, and more particularly, to a heating element and to a method for manufacturing same wherein the heating element comprises a) a transparent substrate, and b) a conductive heating pattern formed on at least one surface of the transparent substrate, wherein the average distance between lines in a vertical direction of the conductive heating pattern is wider than the average distance between lines in a horizontal direction thereof. The heating element according to the present invention not only minimizes the side effects due to diffraction and interference phenomena of light but also exhibits superior heating performance at a low voltage while being invisible.

### TECHNICAL FIELD

The present invention relates to a heating element and a method for manufacturing the same. This application claims priority from Korean Patent Application No. 10-2010-0030030 filed on Apr. 1, 2010, in the KIPO, the disclosure of which is incorporated herein by reference in its entirety.

### BACKGROUND ART

During the winter or on a rainy day, frost is formed on a glass surface of a vehicle because of a difference between temperatures outside and inside of the vehicle. In addition, in the case of an indoor ski resort, a freezing phenomenon occurs because of a temperature difference between the inside of a slope and the outside of the slope. Heating glass has been developed in order to solve the problem.

The heating glass uses a concept where after a hot line sheet is attached to the glass surface or a hot line is directly formed on the glass surface, electricity is applied to both terminals of the hot line to generate heat from the hot line, thereby increasing the temperature of the glass surface. It is important for the heating glass for vehicles or a building to have low resistance in order to smoothly generate heat, and, more importantly, the heating glass should not be unpleasant to the human eyes. Accordingly, a known heating glass has been manufactured by forming a heating layer through a sputtering process using a transparent conductive material such as ITO (Indium Tin Oxide) or Ag thin film and connecting an electrode to a front end thereof. In another method, a fine pattern that cannot be recognized by a person may be manufactured by a photolithography manner. As described above, the conductive fine pattern may be manufactured to be applied to various fields such as heating elements and conductors, but there are problems in that visibility or optical property is not good according to a line width or a pitch of the pattern or a shape of the pattern.

### DETAILED DESCRIPTION OF THE INVENTION

### Technical Problem

The present invention has been made in an effort to provide a heating element including a conductive heating pattern that is not visible and can minimize side effects by diffraction and interference phenomena of light, and a method of manufacturing the same.

### Technical Solution

An exemplary embodiment of the present invention provides a heating element including: a) a transparent substrate, and b) a conductive heating pattern formed on at least one surface of the transparent substrate and having a shape where an average distance between lines in a vertical direction is wider than an average distance between lines in a horizontal.

Another exemplary embodiment of the present invention provides a method of manufacturing a heating element, including: forming a conductive heating pattern having a shape where an average distance between lines in a vertical direction is wider than an average distance between lines in a horizontal direction on one surface of a transparent substrate.

### Advantageous Effects

According to the exemplary embodiments of the present invention, the heating element including the pattern according to the present invention can minimize side effects due to diffraction and interference phenomena of light, has excellent heating performance at a low voltage and is not visible.

### BRIEF DESCRIPTION OF DRAWINGS

FIG. 1 illustrates a conductive heating pattern of a heating element according to Example 1 that is an exemplary embodiment of the present invention.

FIG. 2 relates to a measurement result of Example 1 that is an exemplary embodiment of the present invention, and illustrates a picture of an interference pattern of light passing through the heating element manufactured in Example 1.

FIG. 3 illustrates a conductive heating pattern of a heating element according to Comparative Example 1.

FIG. 4 relates to a measurement result of Comparative Example 1, and illustrates a picture of an interference pattern of light passing through the heating element manufactured in Comparative Example 1.

FIG. 5 illustrates a device constitution for measuring the intensity of light passing through the heating element according to the exemplary embodiment of the present invention.

FIG. 6 illustrates the conductive heating pattern of the heating element according to the exemplary embodiment of the present invention.

FIG. 7 illustrates arrangement of a Delaunay pattern generator according to the exemplary embodiment of the present invention.

### BEST MODE

Hereinafter, the present invention will be described in detail.

A heating element according to the present invention includes a) a transparent substrate, and b) a conductive heating pattern formed on at least one surface of the transparent substrate and having a shape where an average distance between lines in a vertical direction is wider than an average distance between lines in a horizontal direction.

In the present invention, when the heating element is applied to a final purpose, left and right directions are set as a horizontal direction and upper and lower directions are set as a vertical direction based on a direction that a user of products of the final purpose watches the heating element. For example, in the case where the heating element is applied to glass for vehicles, since the user watches the heating element while sitting in the vehicle, a direction that is parallel to the ground on which the vehicle stops is the horizontal direction, and a direction that is perpendicular to the ground on which the vehicle stops is the vertical direction. In the present invention, an average distance between lines in a horizontal direction or an average distance between lines in a vertical direction means an average value of values obtained by measuring all distances between lines in a predetermined direction.

The heating element according to the present invention may further include, in addition to a) the transparent substrate and b) the conductive heating pattern, c) a bus bar electrically connected to both ends of the conductive heating pattern and d) a power portion connected to the bus bar.

However, an effect of adjusting diffraction and interference directions of light into one direction needs to be increased according to a position to which the pattern is applied. That is, in the case where the base to which the pattern is to be applied allows the diffraction and interference directions of light to have directivity, in particular, in the case where the product, such as a front window for vehicles, to which the pattern is to be applied, is a base that is tilted at a predetermined angle or allows light to have directivity, an effect of adjusting diffraction and interference directions of light into one direction needs to be increased.

Accordingly, in the aforementioned case, it is possible to significantly reduce the effect of diffraction and interference of light by using a shape where an average distance between lines in a vertical direction is wider than an average distance between lines in a horizontal direction. In this case, the average distance between lines in a vertical direction is preferably 1 to 10 times and more preferably 2 to 5 times as large as the average distance between lines in a horizontal direction. That is, directivity of diffraction and interference forms of light may be controlled according to the purpose of application of the conductive heating pattern.

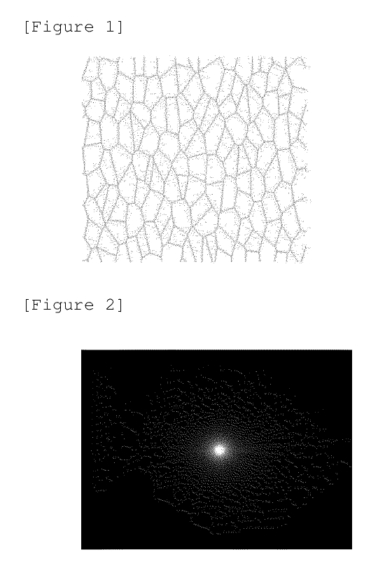

For example, in the case where the pattern is applied to the front window for vehicles, since the front window is tilted at an angle of about 30° to the ground, when the average distance between lines in a horizontal direction and the average distance between lines in a vertical direction are similar to each other, in view of an external light source, it seems that the average distance between lines in a vertical direction is smaller than the average distance between lines in a horizontal direction. Accordingly, in this case, the effect of diffraction and interference of light is largely shown in a vertical direction. In this case, if the pattern is manufactured so that the average distance between lines in a vertical direction is intentionally larger than, for example, about two times larger than the average horizontal direction in a design step of the pattern, the effect of diffraction and interference of light having directivity can be removed. An example of the conductive heating pattern is shown in FIG. 1, but the scope of the present invention is not limited thereto.

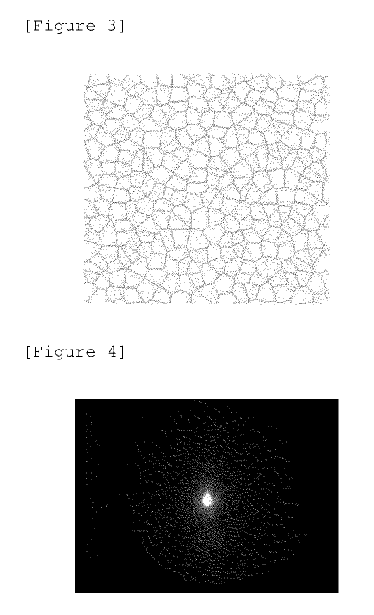

FIG. 1 exemplifies a conductive heating pattern according to an exemplary embodiment of the present invention. The heating pattern of FIG. 1 has a shape where the average distance between lines in a vertical direction is two times as large as the average distance between lines in a horizontal direction, and the result obtained by photographing the pattern at an angle of about 30° to a camera is shown in FIG. 2. From FIG. 2, it can be confirmed that light does not spread in one direction but in all directions, and according to the present invention, it can be seen that it is possible to minimize side effects by diffraction and interference of light.

The conductive heating pattern included in the heating element according to the present invention, as described above, is not particularly limited but may have various shapes as long as the average distance between lines in a vertical direction is wider than the average distance between lines in a horizontal direction. In the present invention, the heating line of the heating pattern may be a straight line, and various modifications such as curved lines, wave lines, and zigzag lines may be feasible.

In the present invention, a regular pattern may be used or an irregular pattern may be used as the conductive heating pattern. For example, a very regular pattern such as a grid manner or a linear manner may be used as the conductive heating pattern with respect to the shape of the conductive heating pattern.

In the present invention, it is preferable to use the irregular pattern as the conductive heating pattern. In the case where the irregular pattern is used, it is possible to minimize the diffraction and interference patterns of light caused by a difference in refractive index between the conductive heating pattern and glass. The irregular patterns minimize the effect of diffraction and interference patterns of light by a single light source, which is present after the sunset, such as headlights for vehicles or streetlamps. Accordingly, it is possible to ensure safety of a driver and prevent tiredness of the driver from being increased. In the present invention, the irregular conductive heating pattern is formed to correspond to 30% or more, preferably 70% or more, and more preferably 90% or more of the entire area of the transparent substrate.

According to the exemplary embodiment of the present invention, a pattern where a ratio (distance distribution ratio) of a standard deviation to an average value of distances between adjacent intersection points of the straight line and the conductive heating pattern is 2% or more when a straight line crossing the conductive heating pattern is drawn may be used as the conductive heating pattern. It is possible to prevent side effects by the diffraction and the interference of the light source that can be detected by the naked eye in a dark area by the pattern as described above.

The crossing straight line means a line where the distance deviation of the most closely adjacent intersection points of the pattern generated by the line has a small value. Alternatively, the straight line may be a line in a direction that is perpendicular to the tangent line of any one point.

It is preferable that the straight line crossing the conductive heating pattern be a line where the standard deviation of the distances between adjacent intersection points of the straight line and the conductive heating pattern has the smallest value. Alternatively, it is preferable that the straight line crossing the conductive heating pattern be a straight line extending in a direction that is perpendicular to the tangent line of any one point of the conductive heating pattern.

It is preferable that the number of intersection points of the straight line crossing the conductive heating pattern and the conductive heating line be 80 or more.

The ratio (distance distribution ratio) of standard deviation in respects to an average value of distances between adjacent intersection points of the straight line crossing the conductive heating pattern and the conductive heating pattern is preferably 2% or more, more preferably 10% or more, and even more preferably 20% or more.

In addition to the aforementioned heating pattern, another type of conductive heating pattern may be provided on at least a portion of the surface of the transparent substrate.

In another exemplary embodiment of the present invention, a pattern that is formed of closed figures having a continuous distribution and has a ratio (area distribution ratio) of a standard deviation to an average value of areas of the closed figures of 2% or more may be used as the conductive heating pattern.

It is preferable that at least 100 closed figures be present.

The ratio (area distribution ratio) of the standard deviation to the average value of areas of the closed figures is preferably 2% or more, more preferably 10% or more, even more preferably 20% or more.

Another type of conductive heating pattern may be formed on at least a portion of the surface of the transparent substrate including the heating pattern where a ratio (area distribution ratio) of a standard deviation to an average value of the areas is 2% or more.

Meanwhile, in the case where the conductive heating pattern is formed of the irregular pattern, it is preferable that distribution of the irregular patterns be uniformalized in the present invention in order to prevent a problem that the pattern is visible due to a difference between dense and loose portions in distribution of the lines. For example, it is preferable that an opening ratio of the conductive heating pattern be constant in a unit area in order to uniformalize the distribution of the pattern. It is preferable that a permeability deviation of the conductive heating pattern be 5% or less with respect to a predetermined circle having a diameter of 20 cm. In this case, it is possible to reduce visibility of the conductive heating pattern and prevent local heating of the heating element. In the heating element, it is preferable that after the heating, the standard deviation of the surface temperature of the transparent substrate be within 20%.

According to the exemplary embodiment of the present invention, the conductive heating pattern may be a boundary shape of the figures forming a Voronoi diagram. It is preferable that at least one of the figures forming the pattern in the unit area have the shape that is different from those of the remaining figures.

The Voronoi diagram is a pattern that is formed by filling the closest area to the corresponding dot as compared to the distance of each dot from the other dots if Voronoi diagram generator dots are disposed in a desired area to be filled. In the present invention, in the case where the conductive heating pattern is formed by using a Voronoi diagram generator, there is an advantage in that the complex pattern form that can minimize the side effects by the diffraction and interference of light can be easily determined.

When the Voronoi diagram generator is generated, regularity and irregularity may be appropriately harmonized. For example, after an area having a predetermined size is set as a basic unit in an area in which the pattern is to be provided, dots are generated so that the distribution of the dots in the basic unit has irregularity, thus manufacturing the Voronoi pattern. If the aforementioned method is used, visibility may be compensated by preventing the localization of the distribution of lines at any one point.

As described above, in the present invention, it is preferable that the opening ratio of the pattern be constant in the unit area for uniform heating and visibility of the heating element. To this end, it is preferable that the number of Voronoi diagram generators per unit area be controlled. In this case, when the number of Voronoi diagram generators per unit area is uniformly controlled, the unit area is preferably 5 cm² or less and more preferably 1 cm² or less. The number of Voronoi diagram generators per unit area is preferably 25 to 2,500/cm² and more preferably 100 to 2,000/cm².

As described above, it can be seen that the problems of the known conductive heating pattern can be solved by forming the pattern having irregularity after distribution of points at which the lines of the patterns meet is made constant. That is, in the case where the pattern having irregularity is used, when light passes through the pattern, light does not progress in one direction but spreads in all directions, and the effect of diffraction and interference of light can be significantly reduced as compared to the regular pattern.

According to another exemplary embodiment of the present invention, the conductive heating pattern may be a boundary form of the figures that are formed of at least one triangle forming the Delaunay pattern. Specifically, the form of the conductive heating pattern is a boundary form of the triangles forming the Delaunay pattern, a boundary form of the figures that is formed of at least two triangles forming the Delaunay pattern or a combination form thereof.

The side effects by diffraction and interference of light may be minimized by forming the conductive heating pattern in the boundary form of the figures that are formed of at least one triangle forming the Delaunay pattern. The Delaunay pattern is a pattern formed by disposing the Delaunay pattern generator dots in the area in which the pattern is to be filled and drawing a triangle by connecting three dots therearound to each other so that there is no other dot in the circle when the circumcircle including all apexes of the triangle is drawn. Delaunay triangulation and circulation may be repeated based on the Delaunay pattern generator in order to form the pattern. The Delaunay triangulation may be performed in such a way that a thin triangle is avoided by maximizing the minimum angle of all angles of the triangle. The concept of the Delaunay pattern was proposed by Boris Delaunay in 1934. An example of the Delaunay pattern is illustrated in FIG. 6, but the scope of the present invention is not limited thereto.

The pattern of the boundary form of the figures that are formed of at least one triangle forming the Delaunay pattern may use the pattern obtained from the generator by regularly or irregularly positioning the Delaunay pattern generator. In the present invention, in the case where the conductive heating pattern is formed by using the Delaunay pattern generator, there is an advantage in that the complex pattern form that can minimize the side effects by the diffraction and interference of light can be easily determined.

Even in the case where the conductive heating pattern is formed in a boundary form of the figures that are formed of at least one triangle forming the Delaunay pattern, the regularity and irregularity may be appropriately harmonized when the Delaunay pattern generator is generated in order to solve the visual recognition problem as described above. For example, an irregular and uniform standard dot is generated in the area in which the pattern is provided. In this case, irregularity means that the distances between the dots are not constant, and uniformity means that the numbers of dots that are included per unit area are the same as each other.

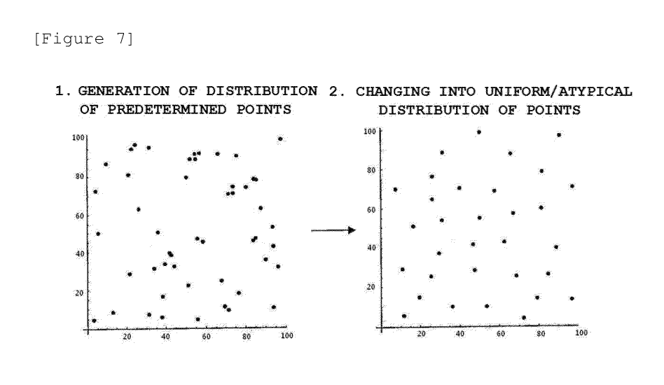

The method for generating the irregular and uniform standard dots will be exemplified below. As shown in FIG. 7, a predetermined dot is generated on the entire area. After that, the interval between the generated dots is measured, and in the case where the interval between the dots is smaller than the value that is set in advance, the dots are removed. In addition, the Delaunay triangle pattern is formed based on the dots, and in the case where the area of the triangle is larger than the value that is set in advance, the dots are added in the triangle. The aforementioned process is performed repeatedly, and as a result, as shown in FIG. 6, the irregular and uniform standard dots are generated. Next, the Delaunay triangles each including one generated standard dot are generated. In this step, the process may be performed by using the Delaunay pattern. If the aforementioned method is used, visibility may be compensated by preventing the localization of the distribution of lines at any one point.

As described above, in the case where the opening ratio of the pattern is made constant in the unit area for the uniform heating and visibility of the heating element, it is preferable to control the number of Delaunay pattern generators per unit area. In this case, when the number of Delaunay pattern generators per unit area is uniformly controlled, it is preferable that the unit area be 10 cm² or less. The number of Delaunay pattern generators per unit area is preferably 10 to 2,500/cm² and more preferably 10 to 2,000/cm².

It is preferable that at least one of the figures forming the pattern in the unit area have the shape that is different from those of the remaining figures.

In the present invention, the transparent substrate is not particularly limited, but it is preferable to use the matter where light transmittance is 50% or more and preferably 75% or more. Specifically, glass may be used as the transparent substrate, and the plastic substrate or plastic film may be used. In the case where the plastic film is used as the transparent substrate, it is preferable that after the conductive heating pattern is formed, glass be bonded to at least one surface of the transparent substrate. In this case, it is more preferable that the glass or plastic substrate be bonded to the surface on which the conductive heating pattern of the transparent substrate is formed. A material that is known in the art may be used as the plastic substrate or film. For example, it is preferable to use the film having the visible ray transmittance of 80% or more such as PET (polyethylene terephthalate), PVB (polyvinylbutyral), PEN (polyethylene naphthalate), PES (polyethersulfon), PC (polycarbonate), and acetyl celluloid. The thickness of the plastic film is preferably 12.5 to 500 μm, and more preferably 30 to 150 μm.

In the present invention, as described above, 30% or more, preferably 70% or more, and more preferably 90% or more of the entire area of the transparent substrate has the irregular conductive heating pattern. For example, the pattern where a ratio (distance distribution ratio) of a standard deviation to an average value of distances between adjacent intersection points of the straight line and the conductive heating pattern is 2% or more when the straight line crossing the conductive heating pattern is drawn, such that it is possible to prevent side effects by the diffraction and interference of the light source that can be detected by the naked eye in a dark area.

According to the exemplary embodiment of the present invention, a heating line of the conductive heating pattern may be blackened.

The conductive heating pattern may be formed so that the area of the pattern that is formed of the figures having the asymmetric structure is 10% or more of the entire pattern area in order to maximize the minimization effect of side effects by the diffraction and interference of light. In addition, in the case where the conductive heating pattern is formed in a boundary form of the Voronoi diagram, the pattern may be formed so that the area of the figures where at least one of the lines that connect the central point of any one figure forming the Voronoi diagram and the central point of the adjacent figure forming the boundary in conjunction with the figure is different from the remaining lines in view of length is 10% or more of the entire conductive heating pattern area. In addition, in the case where the conductive heating pattern is formed by the Delaunay pattern, the pattern may be formed so that the area of the pattern formed of the figures where the length of at least one side forming the figure that is formed of at least one triangle forming the Delaunay pattern is different from the lengths of the other side is 10% or more of the entire conductive heating pattern area.

When the heating pattern is manufactured, after the pattern is designed in a limited area, the method where the limited areas are repeatedly connected may be used to manufacture a large area pattern. The repetitive patterns may be connected to each other by fixing the positions of the dots of each quadrilateral in order to repeatedly connect the patterns. In this case, the limited area has the area of preferably 10 cm² or more and more preferably 100 cm² or more in order to minimize the diffraction and interference by the repetition.

The line width of the heating line of the conductive heating pattern may be 100 micrometers or less, preferably 30 micrometers or less, and more preferably 25 micrometers or less. The interval between the lines of the conductive heating line is preferably 30 mm or less, preferably 50 micrometers to 10 mm, and preferably 200 micrometers to 0.65 mm. The height of the heating line is 1 to 100 micrometers, and more preferably 3 micrometers. Specifically, the average distance between lines in a horizontal direction of the heating pattern is preferably 30 mm or less and more preferably 10 mm or less. Further, the average distance between lines in a vertical direction is preferably 1 to 10 times and more preferably 2 to 5 times as large as the average distance between lines in a horizontal direction.

In the present invention, it is possible to provide a heating element from which an interference pattern generated when light emitted from a light source passes through the heating element is removed and to prevent side effects by the diffraction and interference of a single light source detected by the naked eye in the dark area by making the heating pattern irregular.

Since there may be present a deviation according to the kind of light source, in the present invention, an incandescent lamp of 100 W is used as the standard light source. The intensity of light is measured through a digital camera. The photographing condition of the camera is set so that, for example, F (aperture value) is 3.5, a shutter speed is 1/100, ISO is 400 and a black and white image is ensured. After the image is obtained by using the camera as described above, the intensity of light may be rated through an image analysis.

In the present invention, when the intensity of light is measured, the light source is disposed at the center in the black box having the width of 30 cm, length of 15 cm, and the height of 30 cm, and the device where the circle having the diameter of 12.7 mm is opened before the point of 7.5 cm from the center of the light source is used. The light source of the double phase measurement device according to KS L 2007 standard is adopted. The digital image obtained by using the aforementioned condition is stored in 1600×1200 pixels, the intensity of light per each pixel is represented by the numerical value in the range of 0 to 255, and the area in the light source area per each pixel has the value of 0.1 to 0.16 mm².

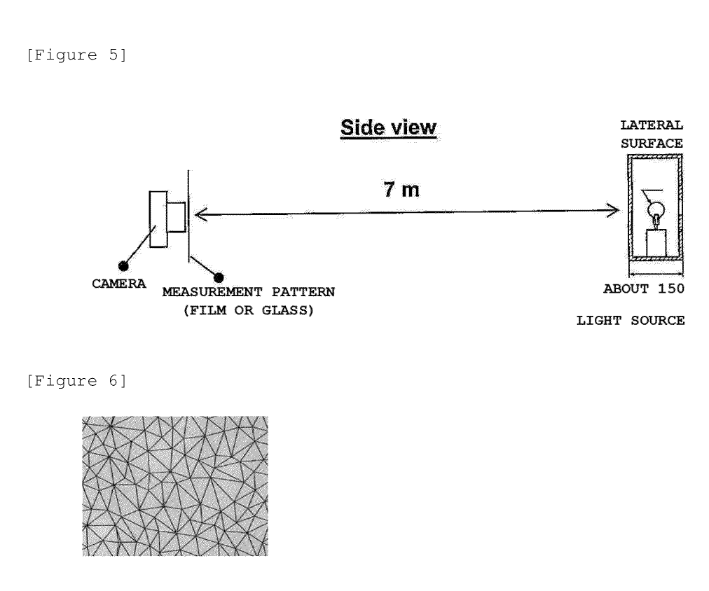

The position of the central pixel of the light source is obtained based on the intensity of light per the pixel of the digital image and based on the sum total of the left and right/upper and lower intensities. The average value of the intensities of light for each 5° is obtained by dividing the sum total of intensities of light of the pixel corresponding to the angle of 5° by the number of the pixels based on the central pixel of the light source. The 1200×1600 pixel is not used as the pixel used in the calculation, and only the pixel present within the distance of 500 or less from the central pixel of the light source when one pixel is considered the distance of 1 by reducing the pixel into the coordinate value is used. Since the average value is calculated as one value for each 5°, if the angle is reduced into 360°, 72 values are obtained. Therefore, the standard deviation calculated in the present invention is a value corresponding to 72 standard deviations. It is preferable that the measurement of the intensity of light be performed in the dark room. FIG. 5 illustrates the constitution of the equipment.

The image of light passing through the heating element obtained in the aforementioned manner may display the black color in the pixel having the intensity of light of 10 or less, the white color in the pixel having the intensity of light of 25 or more, and the gray scale color in the pixel having the intensity of light of 10 to 25. As shown in FIGS. 2 and 4, in products (FIG. 4) obtained by a known technology, the light source has a shape of lengthwise oval in the image obtained by the aforementioned method. However, in the product (FIG. 2) according to the present invention, the shape of the light source is not modified but the original shape thereof is observed. Accordingly, the case where the shape of the light source is not modified in the image of light passing through the heating element is defined by the case where there is substantially no interference pattern. In other words, in the present invention, when light emitted from a light source that is 7 m apart from the heating element passes through the heating element, the fact that the interference pattern is not substantially generated in a circumference direction of the light source means that the image of light having the intensity of 25 or more in light passing through the heating element is not modified in the shape of the light source. For example, in the case where the heating element according to the present invention is tilted at 30° to a vertical line of a ground, when light emitted from a light source that is 7 m apart from the heating element passes through the heating element, it is preferable that an interference pattern be not substantially generated in a circumference direction of the light source.

The present invention provides a method of manufacturing a heating element, including: forming a conductive heating pattern having a shape where an average distance between lines in a vertical direction is wider than an average distance between lines in a horizontal direction on one surface of a transparent substrate.

In the method for manufacturing the heating element according to the present invention, forming a bus bar electrically connected to both ends of the conductive heating pattern and providing a power portion connected to the bus bar may be further performed. These steps may use a method known in the art. For example, the bus bar may be simultaneously formed in conjunction with the formation of the conductive heating pattern, and may be formed by using the same or different printing method after the conductive heating pattern is formed. For example, after the conductive heating pattern is formed by using an offset printing method, the bus bar may be formed through screen printing. In this case, the thickness of the bus bar is appropriately 1 to 100 μm and preferably 10 to 50 μm. If the thickness is less than 1 micrometer, contact resistance between the conductive heating pattern and the bus bar is increased, such that local heating may be performed at the contact portion, and if the thickness is more than 100 micrometers, cost of the electrode material is increased. The connection between the bus bar and power may be performed through soldering and physical contact with the structure having good conductive heating.

The black pattern may be formed in order to conceal the conductive heating pattern and the bus bar. The black pattern may be printed by using a paste including cobalt oxides. In this case, screen printing is appropriate for the printing method, and the thickness thereof is appropriately 10 to 100 μm. The conductive heating pattern and the bus bar may each be formed before or after the black pattern is formed.

The heating element according to the present invention may include an additional transparent substrate provided on a surface on which the conductive heating pattern of the transparent substrate is provided. An adhesive film may be interposed between the conductive heating pattern and the additional transparent substrate when the additional transparent substrate is attached. The temperature and the pressure may be controlled during the attachment process.

In a specific exemplary embodiment, an attachment film is inserted between the transparent substrate on which the conductive heating pattern is formed and the additional transparent substrate, put into a vacuum bag, and increased in temperature while reducing pressure or increased in temperature by using a hot roll, thus removing the air, thereby accomplishing the first attachment. In this case, the pressure, the temperature and time may depend on a kind of attachment film, but in general, the temperature may be gradually increased from normal temperature to 100° C. at a pressure of 300 to 700 torr. In this case, it is preferable that the time be generally 1 hour or less. The firstly and preliminarily attached laminate is subjected to a second attachment process by an autoclaving process where the temperature is increased while the pressure is applied in the autoclave. The second attachment depends on a kind of attachment film, but it is preferable that after the attachment is performed at the pressure of 140 bar or more and the temperature of about 130 to 150° C. for 1 to 3 hours and preferably about 2 hours, the film be slowly cooled.

In another specific exemplary embodiment, a method of performing attachment through one step by using a vacuum laminator device unlike the aforementioned two step attachment process may be used. The attachment may be performed by increasing the temperature step by step to 80 to 150° C. and performing slow cooling so that the pressure is lowered (˜5 mbar) until the temperature is 100° C. and thereafter the pressure is added (˜1000 mbar).

Any material that has attachment strength and becomes transparent after attachment may be used as the material of the attachment film. For example, a PVB film, an EVA film, a PU film and the like may be used, but the film is not limited thereto. The attachment film is not particularly limited, but it is preferable that the thickness thereof be 100 to 800 μm.

In the aforementioned method, the attached additional transparent substrate may be formed of only the transparent substrate, or may be formed of a transparent substrate that is provided with the conductive heating pattern manufactured as described above.

The heating element according to the present invention may be connected to power for heating, and in this case, the heating amount is 100 to 700 W per m² and preferably 200 to 300 W per m². Since the heating element according to the present invention has excellent heating performance even at a low voltage, for example, 30 V or less, and preferably 20 V or less, the heating element may be usefully used in vehicles and the like. Resistance of the heating element is 1 ohm/square or less, and preferably 0.5 ohm/square or less.

The heating element according to the present invention may have a shape of curved surface.

In the heating element according to the present invention, it is preferable that the opening ratio of the conductive heating pattern, that is, a ratio of a glass area that is not covered with the pattern be 70% or more. The heating element according to the present invention has an excellent heating property where an opening ratio is 70% or more and the temperature is increased while temperature deviation within 5 min after heating operation is maintained at 10% or less.

The heating element according to the present invention may be applied to glass that is used for various transport means such as vehicles, ships, railroads, high-speed railroads and airplanes, houses or other buildings. In particular, since the heating element according to the present invention has an excellent heating property even at a low voltage, can minimize side effects by diffraction and interference of light, and can be formed with the aforementioned line width so as not to be visible, unlike the known technology, the heating element may be applied to a front window for transport means such as vehicles.

As described above, for example, since the front window for vehicles is tilted at an angle of about 30° to the ground, the average distance between lines in a vertical direction is preferably 1 to 10 times and more preferably 2 to 5 times as large as the average distance between lines in a horizontal direction. Further, in the case of glass used for houses or other buildings, the average distance between lines in a vertical direction is preferably 1 to 3 times and more preferably 1 to 2 times as large as the average distance between lines in a horizontal direction.

### [Mode for Invention]

The present invention will be described in detail through the following Examples. However, the Examples are set forth to illustrate but are not to be construed to limit the scope of the present invention.

### EXAMPLE 1

The pattern where the average distance between lines in a vertical direction was two times larger than the average distance between lines in a horizontal direction was manufactured, and the heating pattern is shown in FIG. 1. The pattern was photographed at an angle of about 30° to a camera by using a KS L 2007 vehicle safe glass double phase test method. It was confirmed that light did not spread in one direction but spread in all directions. The measurement results are shown in FIG. 2.

### COMPARATIVE EXAMPLE 1

The pattern was manufactured so that the average distance between lines in a vertical direction was the same as the average distance between lines in a horizontal direction, and the heating pattern is shown in FIG. 3. The pattern was photographed at an angle of about 30° to a camera by using a KS L 2007 vehicle safe glass double phase test method. It was confirmed that light spread in a predetermined vertical direction while being distorted. The measurement results are shown in FIG. 4.

As shown in the Examples and FIGS. 1 to 4, it can be seen that the heating element including the pattern according to the present invention is not visible and has excellent heating performance at a low voltage and an effect minimizing side effects by diffraction and interference phenomena of light as compared to a known heating element.

1. A heating element comprising:
a) a transparent substrate, and
b) a conductive heating pattern formed on at least one surface of the transparent substrate and having a shape where an average distance between lines in a vertical direction is wider than an average distance between lines in a horizontal direction.

2. The heating element of claim 1, wherein where the average distance between lines of the conductive heating pattern in the vertical direction is one to ten times wider than the average distance between lines of the conductive heating pattern in the horizontal direction.

3. The heating element of claim 1, further comprising:
c) a bus bar electrically connected to both ends of the conductive heating pattern, and
d) a power portion connected to the bus bar.

4. The heating element of claim 1, wherein in the case where the heating element is tilted at 30° to a vertical line of a ground, when light emitted from a light source that is 7 m apart from the heating element passes through the heating element, an interference pattern is not substantially generated in a circumference direction of the light source.

5. The heating element of claim 1, wherein the conductive heating pattern is a regular pattern.

6. The heating element of claim 1, wherein the conductive heating pattern is an irregular pattern.

7. The heating element of claim 1, wherein the conductive heating pattern includes a pattern where a ratio (distance distribution ratio) of a standard deviation to an average value of distances between adjacent intersection points of a straight line and the conductive heating pattern is 2% or more when the straight line crossing the conductive heating pattern is drawn.

8. The heating element of claim 1, wherein the conductive heating pattern is formed of closed figures having a continuous distribution and includes a pattern where a ratio (area distribution ratio) of a standard deviation to an average value of areas of the closed figures is 2% or more.

9. The heating element of claim 1, wherein a transmittance deviation to a predetermined circle having a diameter of 20 cm is 5% or less.

10. The heating element of claim 1, wherein the conductive heating pattern includes a pattern of a boundary form of figures forming a Voronoi diagram or a boundary form of figures formed of at least one triangle forming a Delaunay pattern.

11. The heating element of claim 1, wherein a line width of the conductive heating pattern is 100 micrometers or less.

12. The heating element of claim 1, wherein the average distance between lines of the conductive heating pattern in a horizontal direction is 30 mm or less.

13. The heating element of claim 1, wherein another transparent substrate is further provided on a surface on which a conductive heating pattern of the transparent substrate is provided.

14. The heating element of claim 1, wherein the transparent substrate is glass or a plastic substrate or film.

15. The heating element of claim 1, wherein the heating element is a glass for transport means or a building.

16. A glass for transport means or building, comprising:
the heating element of claim 1.

17. The glass for transport means or building of claim 16, wherein the glass is a front window for vehicles.

18. A method of manufacturing a heating element, comprising:
forming a conductive heating pattern having a shape where an average distance between lines in a vertical direction is wider than an average distance between lines in a horizontal direction on one surface of a transparent substrate.

19. The method of manufacturing a heating element of claim 18, further comprising:
forming a bus bar electrically connected to both ends of the conductive heating pattern, and
providing a power portion connected to the bus bar.
